(19) United States
(12) Patent Application Publication
(10) Pub. No.: US 2006/0105802 A1
(43) Pub. Date: May 18, 2006

(54) Communication system with reconfigurable hardware structure and reconfiguration method therefor

(75) Inventors: Jin-Woo Heo, Suwon-si (KR); Ramesh Chambil Palat, Blacksburg, VA (US); Dong-Sam Ha, Blacksburg, VA (US); Jeffrey Hugh Reed, Blacksburg, VA (US); Jina Kim, Blacksburg, VA (US); Jong-Suk Lee, Blacksburg, VA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/260,493

(22) Filed: Oct. 28, 2005

Related U.S. Application Data
(60) Provisional application No. 60/622,788, filed on Oct. 29, 2004.

(51) Int. Cl. H04M 1/00

(52) U.S. Cl. 455/550.1

(57) ABSTRACT

A communication system is provided with a reconfigurable hardware structure to provide implementation flexibility while minimizing a reduction in low power consumption performance. The communication system includes a plurality of processing element (PE) blocks for processing data based on multiple wireless transmission standards, memories for storing data being processed or to be processed by the PE blocks, and a controller for controlling data processing in the PE blocks, a data input operation to the PE blocks and a data output operation from the PE blocks, and for controlling transmission of data being processed in and input/output to/from the PE blocks. Each of the PE blocks includes a plurality of PE modules, and each of the PE modules includes a predetermined number of PEs that perform different functions. Operation and input/output of the PE blocks, the PE modules and the PEs are controlled by the controller.

### CROSS-REFERENCE TO RELATED APPLICATIONS

This application claims the benefit under 35 U.S.C. §119(e) of U.S. Provisional Patent Application No. 60/622,788 entitled “Reconfigurable Hardware Structure Supporting Multiple Wireless Transmission Standards” filed in the United States Patent and Trademark Office on Oct. 29, 2004, the entire contents of which are hereby incorporated by reference.

### BACKGROUND OF THE INVENTION

1. Field of the Invention

The present invention relates generally to a reconfigurable communication system. In particular, the present invention relates to a communication system having a reconfigurable hardware structure to support multiple wireless transmission standards and a reconfiguration method therefor.

2. Description of the Related Art

Conventionally, physical layer design of terminals for communication systems is implemented with Application Specific Integrated Circuits (ASICs) for miniaturization and low-power consumption. Notwithstanding the advantages, however, the ASIC-based implementation has one disadvantage of very low implementation flexibility because once a chip is generated, modification of its internal design is impossible. Another disadvantage is the long design cycle from chip design to chip production.

Recently, wireless transmission standards, such as Code Division Multiple Access 2000 (CDMA2000) and Wideband Code Division Multiple Access (WCDMA), are undergoing rapid evolution. Such evolution is increasing the demand for services that are capable of accessing several wireless transmission standards through one terminal. A terminal capable of supporting wireless transmission standards is required not only to meet the miniaturization and low-power consumption requirements, but also to support multiple wireless transmission standards and to have a shorter design cycle. For example, there is a demand for a terminal supporting both a CDMA2000 1× wireless transmission standard and a WCDMA wireless transmission standard.

As a plan to meet these requirements, a scheme for implementing both of the wireless transmission standards in one chip can be taken into consideration. However, such a scheme increases a chip size due to the inefficient use of computational resources in the chip. Further, when there is a need to add a new wireless transmission standard, the chip must be redesigned. In addition, the long design cycle, which is one problem of the ASIC, results in a long design time in the process of designing a terminal that is capable of supporting multiple wireless transmission standards using the ASIC.

Programmable devices, such as a field programmable gate array (FPGA), a general-purpose processor, and a digital signal processor (DSP), have become alternative plans to meet the short-design cycle requirements. However, the FPGA and the general-purpose processor have the advantage of high implementation flexibility and short design cycle, but have the disadvantage of low computational resource utility and high power consumption, because each are focused on the general purpose application field. The DSP is a device that has high implementation flexibility and is very suitable for the digital signal processing field. However, due to its low operating frequency, the DSP is insufficient to meet all of the requirements of the communication systems that require high computation power.

A great degree of research is being conducted on a structure that is capable of taking into account implementation flexibility of the programmable hardware function, while maintaining the current ASIC's advantage of low power consumption performance. Machines including the reconfigurable hardware are called “configuration computing machines (CCMs)”. Because conventional CCMs lay great emphasis on reconfigurable functions rather than low power consumption, they are not suitable to be applied to a wireless terminal that requires high computational processing capability, miniaturization, and low power consumption.

Accordingly, in order to use reconfigurable hardware for wireless terminals, there is a need to design a structure in which such factors as low power consumption, small hardware size and reconfiguration flexibility are taken into consideration.

### SUMMARY OF THE INVENTION

It is, therefore, an object of the present invention to substantially solve the above and other problems, and to provide a communication system having a hardware structure that is capable of reconfiguring multiple wireless transmission standards, the system providing implementation flexibility while minimizing a reduction in low power consumption performance, and a reconfiguration method therefor.

According to one aspect of the present invention, a communication system is provided having a reconfigurable hardware structure. The communication system comprises a plurality of processing element (PE) blocks for processing data based on multiple wireless transmission standards, memories for storing data being processed or to be processed by the PE blocks, and a controller for controlling data processing in the PE blocks, a data input operation to the PE blocks and a data output operation from the PE blocks, and controlling transmission of data being processed in and input/output to/from the PE blocks. Each of the PE blocks comprises a plurality of PE modules, and each of the PE modules comprises a predetermined number of PEs that perform different functions, and the operation and input/output of the PE blocks, the PE modules and the PEs are controlled by the controller.

According to another aspect of the present invention, a communication system is provided having a reconfigurable hardware structure. The communication system comprises first and second processing element (PE) blocks for processing data based on multiple wireless transmission standards, an input buffer for storing input data, a first block memory for storing data being processed or to be processed by the first PE block, a second block memory for storing data being processed or to be processed by the second PE block, a transfer memory for storing data transmitted between the first PE block and the second PE block, and a controller for controlling data processing in the first and second PE blocks, a data input operation to the first and second PE blocks and a data output operation from the first and second PE blocks, and controlling transmission of data being processed in and input/output to/from the first and second PE blocks. Each of the first and second PE blocks comprises one or more PE modules, and each of the PE modules comprises a predetermined number of PEs that perform different functions, and operation and input/output of the first and second PE blocks, the PE modules and the PEs are controlled by the controller.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a configuration of a communication system having a reconfigurable hardware structure according to an embodiment of the present invention;

FIG. 2 is a diagram illustrating a configuration of a PEA among PEs according to an embodiment of the present invention, in which the PEA can comprise a PE that performs a bit-by-bit operation like a code generator;

FIG. 3 is a diagram illustrating a detailed structure of the CLFSR0 shown in FIG. 2;

FIG. 4 is a diagram illustrating a detailed structure of the CLFSR2 shown in FIG. 2;

FIG. 5 is a diagram illustrating a configuration of a PEB among PEs according to an embodiment of the present invention, in which the PEB can comprise a PE that aims at performing a correlation operation to a 1-bit code for a multi-bit input value;

FIG. 6 is a diagram illustrating a configuration of a PEC among PEs according to an embodiment of the present invention, in which the PEC can comprise a PE that aims at performing a multiplier and accumulator (MAC) operation;

FIG. 7 is a diagram illustrating a configuration of a PED among PEs according to an embodiment to the present invention;

FIG. 8 is a diagram illustrating a configuration of a PEA module according to an embodiment of the present invention, in which the PEA module comprises four PEAs PEA0˜PEA3 by way of example;

FIG. 9 is a diagram illustrating a configuration of a PEB module according to an embodiment of the present invention, in which the PEB module comprises four PEBs PEB0˜PEB3 by way of example;

FIG. 10 is a diagram illustrating a configuration of a PEC module according to an embodiment of the present invention, in which the PEC module comprises four PECs PEC0˜PEC3;

FIG. 11 is a diagram illustrating a configuration of a PED module according to an embodiment of the present invention, in which the PED module comprises four PEDs PED0˜PED3;

FIG. 12 is a diagram illustrating a configuration of a PEAB block according to an embodiment of the present invention;

FIG. 13 is a diagram illustrating a configuration of a PECD block according to an embodiment of the present invention;

FIG. 14 is a diagram illustrating an exemplary interconnection for data transmission between a global memory and PE blocks according to an embodiment of the present invention; and

FIG. 15 is a diagram illustrating an exemplary interconnection between an input buffer, PEAB block's local memories, and PECD block's local memories according to an embodiment of the present invention.

### DETAILED DESCRIPTION OF EXEMPLARY EMBODIMENTS

Exemplary embodiments of the present invention will now be described in detail with reference to the annexed drawings. In the drawings, the same or similar elements are denoted by the same reference numerals, even though they are depicted in different drawings. In the following description, a detailed description of known functions and configurations incorporated herein has been omitted for clarity and conciseness.

In the following description, embodiments of the present invention provide a reconfigurable hardware structure providing function implementation flexibility of the general-purpose processors, at the sacrifice of a slight reduction in low power consumption performance which is the advantage of the ASIC. In particular, embodiments of the present invention provide a structure comprised of several heterogeneous processing elements (PEs), taking functions of WCDMA2000 and WCDMA wireless transmission standards into account to minimize a reduction in low power consumption performance. In addition, embodiments of the present invention provide both an arrangement structure of the PEs and an interconnection structure with a memory in order to implement the necessary function using the PEs.

Embodiments of the present invention propose reconfigurable hardware comprised of reconfigurable PEs that perform different functions. The reconfigurable PEs include PEs for supporting CDMA2000 and WCDMA wireless transmission standards, but are not limited thereto. The PEs' operation and all operations related to data transmission are achieved by individual controllers for controlling the operations. Input/output ports and buses for data transmission between PEs, global memories, and interconnections with the PEs are also reconfigurable. The reconfiguration of the reconfigurable hardware is performed according to control signals generated by corresponding controllers. Each controller stores a control sequence in an internal memory, and generates a control signal using a state machine therein. Embodiments of the present invention fix a data bit width taking into account the regularity of data processing, the expediency of efficient compiler design, and the expandability of calculation blocks, and sets the data bit width to 32 bits through an analysis of function blocks supporting the CDMA2000 and WCDMA wireless standards.

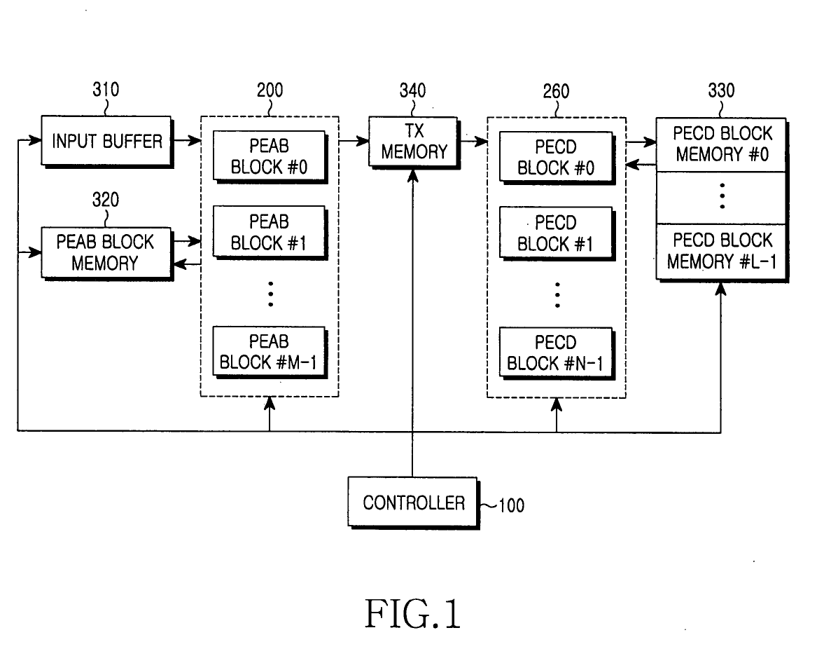

FIG. 1 is a block diagram illustrating a configuration of a communication system having a reconfigurable hardware structure according to an embodiment of the present invention.

Referring to FIG. 1, the reconfigurable hardware according to an embodiment of the present invention comprises memories for storing data, a plurality of PE blocks 200 and 260, and a controller 100 for controlling the reconfiguration of these elements. The memories comprise an input buffer 310, local memories (not shown) in the PE blocks, and a global memory. A PEAB block memory 320, a transfer memory 340, and a PECD block memory 330 comprise the global memory. The PE blocks are provided for performing calculation functions and comprise PEAB blocks 200 and PECD blocks 260 according to their types. Each of the PEAB blocks 200 and the PECD blocks 260 is configured with PE modules, and each PE module is configured with PEs. A basic unit constituting the PEAB blocks 200 and the PECD blocks 260 is a PE.

In an exemplary embodiment of the present invention, there are 4 reconfigurable PEs that perform different functions. The 4 PEs comprise a PEA, a PEB, a PEC and a PED. A predetermined number (for example, 4) of PEs are grouped, to comprise a PE module. For example, 4 PEAs are grouped to comprise a PEA module, 4 PEBs are grouped to comprise a PEB module, 4 PECs are grouped to comprise a PEC module, and 4 PEDs are grouped to comprise a PED module.

The PE modules performing different functions comprise a PE block. An exemplary embodiment of the present invention configures a PEAB block by grouping 4 PEA modules and 1 PEB module and configures a PECD block by grouping 4 PED modules and 1 PEC module, taking an application field into consideration. In order to increase the required number of PEs, the number of PE blocks can be increased. Actually, embodiments of the present invention provide “M” number of PEAB blocks and “N” number of PECD blocks taking into account the expandability during chip implementation. The hierarchical structure of PE, PE modules and PE blocks is subject to hierarchical connection, even in the data transmission connection between PEs. Although PEs in the same PE module are possible for direct connection, data transmission of PEs located in different PE modules is achieved through per-PE module input/output ports. This is to solve the problem that when all PEs have direct connection to each other, extravagant routing line costs for supporting the direct connection must be paid. That is, the hierarchical structure enables the direct connection for the PE connection type within a particular range.

The controller 100 comprises individual controllers for PE blocks, PE modules and PEs. Specifically, the controller 100 can comprise a PEA controller for PEAs, a PEB controller for PEBs, a PEC controller for PECs, a PED controller for PEDs, a PEA module controller for PEA modules, a PEAB block memory controller for shifting data in a PEAB block memory, a PECD block memory controller for shifting data in a PECD block memory, a transfer memory controller for shifting data in a transfer memory, and a local memory bus controller.

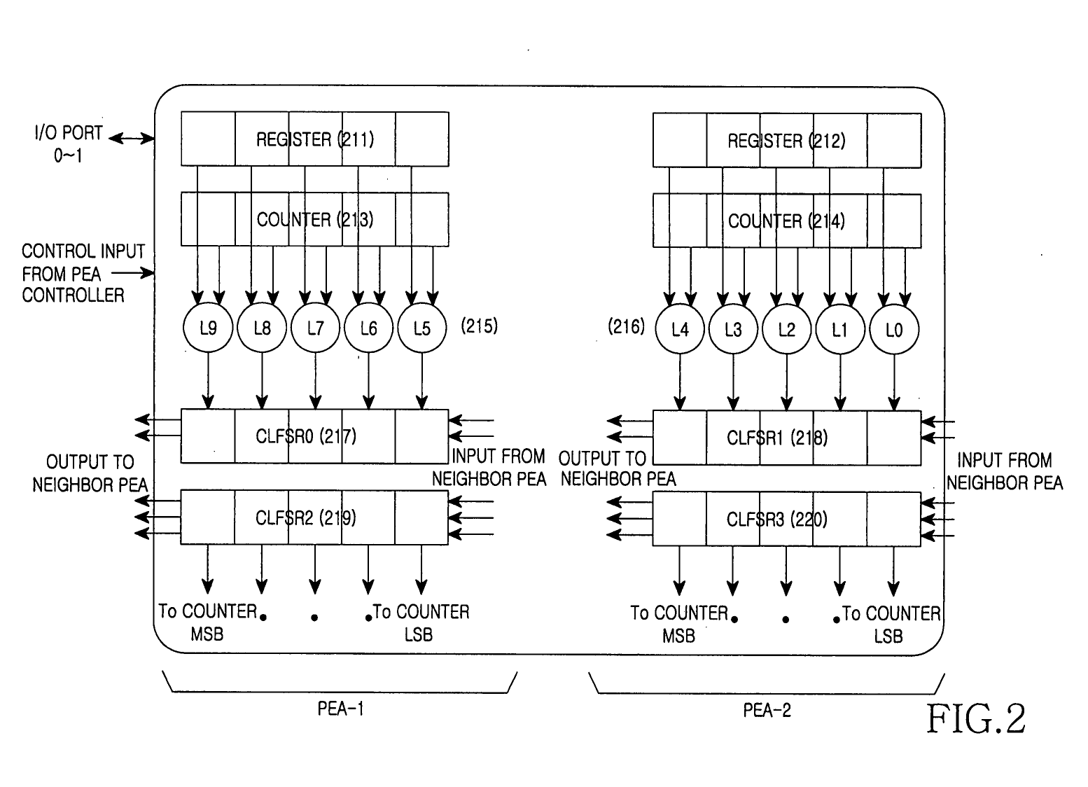

FIG. 2 is a diagram illustrating a configuration of a PEA among PEs according to an embodiment of the present invention. The PEA can be a PE that performs a bit-by-bit operation like a code generator.

Referring to FIG. 2, a PEA comprises operation parts PEA-1 and PEA-2 that simultaneously perform the same two operations and have the same structure. Each of the operation parts comprises function units (FUs) of a 5-bit register 211 (212), a 5-bit counter 213 (214), five 1-bit 2-input logic gates 215 (216), two configurable linear feedback shift registers (CLFSRs) 217 and 219 (218 and 220). An input/output interface comprises two input/output ports (represented herein by “inout ports”) connected to two PEA module ports, an input/output for connecting with a CLFSR of a neighboring PEA, and a control input from a PEA controller. Input/output and operation of the PEA are controlled by the PEA controller.

The input/output of the PEA is expressed with 32 bits. This is because the input/output bits of the PEA include a 5-bit value of the 5-bit register 211, a 5-bit value of the 5-bit counter 213, two 5-bit values calculated by the respective 5-bit logic gates 215 and 216, a 1-bit value of a left 5-bit CLFSR, a 1-bit value of a right 5-bit CLFSR, an output value of the left CLFSR and an output value of the right CLFSR in the order of the least significant bit (LSB) to the most significant bit (MSB). Input/output of each of the PEB, the PEC and the PED is also expressed with 32 bits, and these 32-bit values, compared with that of the PEA, represent result values calculated by their PEs.

Because the PEA includes two left and right operation parts that perform the same operation and have the same structure, only the left operation part PEA-1 will be described for simplicity. Although a description of the right operation part PEA-2 will not be given, it is equal to the description of the left operation part PEA-1.

The 32-bit data input from the input/output ports is loaded into the register 211 and the counter 213. The data loaded into the register 211 and the counter 213 undergoes logic computation by the logic gates 215, and the computation result is provided to the CLFSR0 217 and the CLFSR2 219. The CLFSR is a reconfigurable LFSR. A count value from the counter 213 may be directly loaded into the CLFSRs 217 and 219 according to a control signal. The CLFSR0 217 and the CLFSR2 219 are selectively used according to a structure of the LFSR. The CLFSR0 217 is used to implement an orthogonal variable spreading factor (OVSF) code (or Walsh code) generator, and the CLFSR2 219 is used to implement a WCDMA scrambling code and/or CDMA2000 15-bit pseudo noise (PN) code generator or a long code generator. In order to implement an LFSR having a desired bit length, the CLFSR0 217 (or CLFSR2 219) can be connected to a CLFSR0 (or CLFSR2) of another PEA. For example, in order to implement a 9-bit Walsh code generator, two CLFSR0s are connected to each other. The connected two CLFSR0s constitute a 10-bit internal register, and only 9 of the 10 registers are used to implement a 9-bit Walsh code generator.

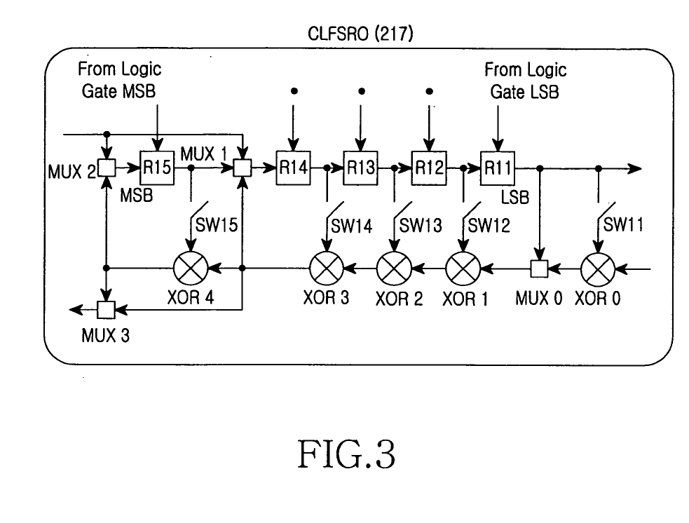

FIG. 3 is a diagram illustrating a detailed structure of the CLFSR0 217 shown in FIG. 2.

Referring to FIG. 3, the CLFSR0 217 comprises 5-bit registers R15˜R11, five 2-input exclusive OR gates XOR4˜XOR0, five switches SW15˜SW11, and four multiplexer MUX3˜MUX0. The CLFSR0 217 has two input/outputs, and the input/outputs are directly connected to input/outputs of a CLFSR0 in a neighboring PEA. The final output value of the CLFSR0 217, an output value of the MUX3, is stored in an input/output interface of a PEA and provided to an input of a 3-bit XOR gate of a PEB via input/output ports of the PEA. According to a structure of a code generator, a MUX selects an input data path, and an XOR gate performs an XOR operation on its inputs. Each switch performs an ON/OFF operation on its associated XOR input. That is, when the switched is turned ON, one input to its associated XOR gate is provided, and when the switched is turned OFF, one input to its associated XOR gate is not provided.

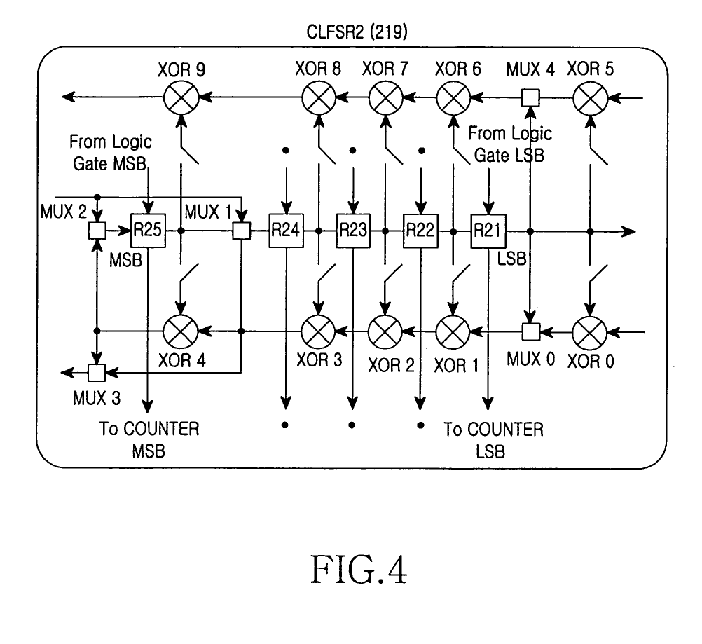

FIG. 4 is a diagram illustrating a detailed structure of the CLFSR2 219 shown in FIG. 2.

Referring to FIG. 4, the CLFSR2 219 comprises 5-bit registers R25˜R21, ten 2-input XOR gates XOR9˜XOR0, ten switches SW30˜SW21, and four MUXs MUX3˜MUX0. The CLFSR2 219 has three input/outputs, and the input/outputs are directly connected to input/outputs of a CLFSR2 in a neighboring PEA. The final output values of the CLFSR2 219, which are an output value of the XOR9 and an LSB value of the register R21, are stored in an input/output interface of a PEA and provided to an input of a 3-bit XOR gate of a PEB via input/output ports of the PEA. According to a structure of a code generator, a MUX selects an input data path, and an XOR gate performs an XOR operation on its inputs. Each switch performs an ON/OFF operation on its associated XOR input. That is, when the switched is turned ON, one input to its associated XOR gate is provided, and when the switched is turned OFF, one input to its associated XOR gate is not provided. Unlike the CLFSR0 217, the CLFSR2 219 can implement a CDMA2000 long code generator by allowing an internal register value of an LFSR to be fed back to the counter 213 of FIG. 2.

Table 1 through Table 3 below show exemplary definitions of each control field and its operation of a PEA with the structures as shown in FIGS. 2 through 4. The operation of the PEA using the various control fields is controlled by a PEA controller (not shown) in the controller 100 shown in FIG. 1.

Table 1 below shows exemplary definitions of each operation control field and its operation of the PEA. These definitions are applied to each of the PEA-1 and the PEA-2 in the PEA. For a function unit (FU) of the CLFSR0 shown in FIG. 3, a control signal (bit numbers 0˜4) is provided for determining whether to connect a switch connected to each of the five 2-input XOR gates XOR0˜XOR4, and a control signal (bit numbers 5˜9) is provided for determining which input each of the four MUXs MUX0˜MUX3 will select. In addition, by using bit numbers 33 and 34, it is possible to load an external value as an input value of an internal register of the CLFSR0, keep the current value, receive an input from a logic gate, or initialize with a zero (0).

For the CLFSR2 shown in FIG. 4, a control signal (bit numbers 10˜14 and 20˜24) is provided for determining whether to connect a switch connected to each of the ten 2-input XOR gates XOR0˜XOR9, and a control signal (bit numbers 15˜19) is provided for determining which input each of the five MUXs MUX0˜MUX4 will select. In addition, by using bit number 35, it is possible to load an external value as an input value of an internal register of the CLFSR2, or keep the current value. The 5-bit logic gate block determines an AND or XOR operation for each bit using a 5-bit control signal (bit numbers 25˜29). Using a bit number 30, the register can be controlled to determine whether to load a new value or continuously use the previous value stored in the register. The counter can initialize with zero, increase one by one, or keep the current value, using bit numbers 31 and 32.

Table 2 below shows exemplary definitions of an input control field and its operation of the PEA. As described above, the PEA comprises two parts that simultaneously perform the same two operations and have the same structure. Inputs Input0 and Input1 to the two individual parts are controlled to be connected to or disconnected from input/output ports of the two parts.

Table 3 shows exemplary definitions of an output control field and its operation of the PEA. Two input/output ports of the PEA are directly connected to two input/output ports MIF0 (module interface 0) and MIF1 (module interface 1) of the PEA module. The PEA input/output ports are controlled to be connected to or disconnected from input/output ports of the PEA module in accordance with Table 3.

TABLE 1

| Bit number | FU | Bit value | Operation |
|---|---|---|---|
| 0 | CLFSR 0 | 0 | XOR 0 disconnect |
| | | 1 | XOR 0 connect |
| 1 | | 0 | XOR 1 disconnect |
| | | 1 | XOR 1 connect |
| 2 | | 0 | XOR 2 disconnect |
| | | 1 | XOR 2 connect |
| 3 | | 0 | XOR 3 disconnect |
| | | 1 | XOR 3 connect |
| 4 | | 0 | XOR 4 disconnect |
| | | 1 | XOR 4 connect |
| 5 | | 0 | MUX 0 connect input |
| | | 1 | MUX 0 connect LSB output |
| 6, 7 | | 0 | MUX 1 connect input |
| | | 1 | MUX 1 connect MSB output |
| | | 2 | MUX 1 connect XOR 3 output |
| 8 | | 0 | MUX 2 connect input |
| | | 1 | MUX 2 connect XOR 4 output |
| 9 | | 0 | MUX 3 connect XOR 3 output |
| | | 1 | MUX 3 connect XOR 4 output |
| 10 | CLFSR 2 | 0 | XOR 0 disconnect |
| | | 1 | XOR 0 connect |
| 11 | | 0 | XOR 1 disconnect |
| | | 1 | XOR 1 connect |
| 12 | | 0 | XOR 2 disconnect |
| | | 1 | XOR 2 connect |
| 13 | | 0 | XOR 3 disconnect |
| | | 1 | XOR 3 connect |
| 14 | | 0 | XOR 4 disconnect |
| | | 1 | XOR 4 connect |
| 15 | | 0 | MUX 0 & 4 connect input |
| | | 1 | MUX 0 & 4 connect LSB |
| | | | output |
| 16, 17 | | 0 | MUX 1 connect input |
| | | 1 | MUX 1 connect MSB output |
| | | 2 | MUX 1 connect XOR 3 output |
| 18 | | 0 | MUX 2 connect input |
| | | 1 | MUX 2 connect XOR 4 output |
| 19 | | 0 | MUX 3 connect XOR 3 output |
| | | 1 | MUX 3 connect XOR 4 output |
| 20 | | 0 | XOR 5 disconnect |
| | | 1 | XOR 5 connect |
| 21 | | 0 | XOR 6 disconnect |
| | | 1 | XOR 6 connect |
| 22 | | 0 | XOR 7 disconnect |
| | | 1 | XOR 7 connect |
| 23 | | 0 | XOR 8 disconnect |
| | | 1 | XOR 8 connect |
| 24 | | 0 | XOR 9 disconnect |
| | | 1 | XOR 9 connect |
| 25 | Logic gate 0 | 0 | AND |
| | | 1 | XOR |
| 26 | Logic gate 1 | 0 | AND |
| | | 1 | XOR |
| 27 | Logic gate 2 | 0 | AND |
| | | 1 | XOR |
| 28 | Logic gate 3 | 0 | AND |
| | | 1 | XOR |
| 29 | Logic gate 4 | 0 | AND |
| | | 1 | XOR |
| 30 | Register | 0 | Initialize with a new value |
| | | 1 | Keep current value |
| 31, 32 | Counter | 0 | Reset to 0 |
| | | 1 | Increment by 1 |
| | | 2 | Keep current value |
| 33, 34 | CLFSR0 | 0 | Load external value |
| | | 1 | Keep current value |
| | | 2 | Load logic gate output |
| | | 3 | Reset |
| 35 | CLFSR 2 | 0 | Initialize with a new value |
| | | 1 | Keep current value |

TABLE 2

| Bit number | FU | Bit value | Operation |
|---|---|---|---|
| 0 | Input 0 | 0 | Connect to the Inout Port 0 |
| | | 1 | Disconnect from the Inout Port 0 |
| 1 | | 0 | Connect to the Inout Port 1 |
| | | 1 | Disconnect from the Inout Port 1 |
| 2 | Input 1 | 0 | Connect to the Inout Port 0 |
| | | 1 | Disconnect from the Inout Port 0 |
| 3 | | 0 | Connect to the Inout Port 1 |
| | | 1 | Disconnect from the Inout Port 1 |

TABLE 3

| Bit number | FU | Bit value | Operation |
|---|---|---|---|
| 0 | MIF0 (PEA Module Interface 0) | 0 | No output |
| | | 1 | Output |
| 1 | MIF1 (PEA Module Interface 1) | 0 | No output |
| | | 1 | Output |

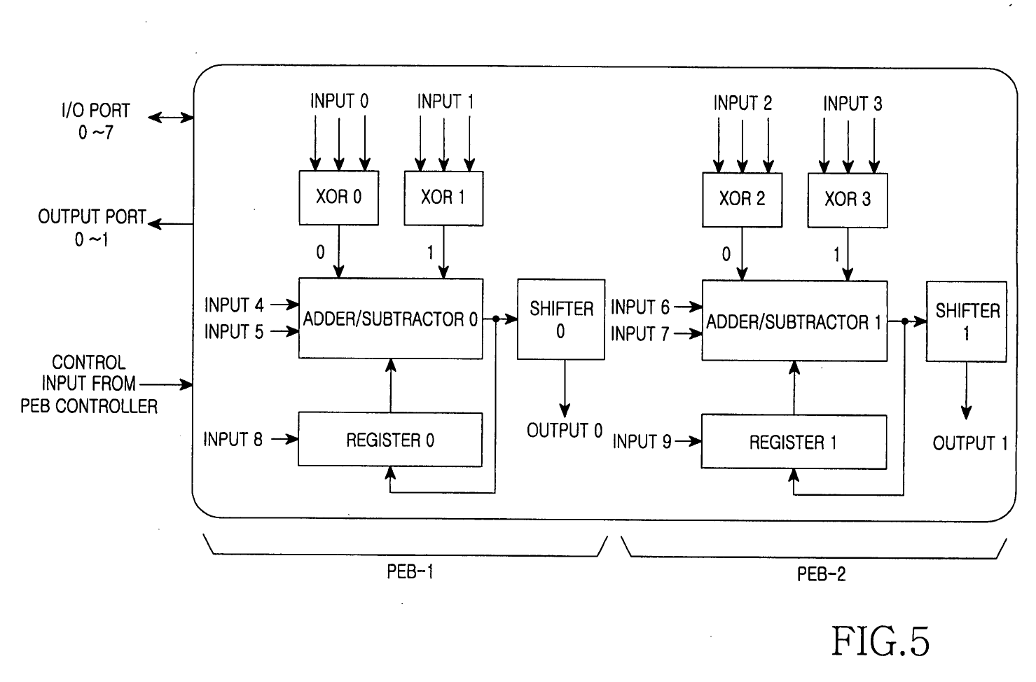

FIG. 5 is a diagram illustrating a configuration of a PEB among PEs according to an embodiment of the present invention. The PEB can be a PE that aims at performing a correlation operation to a 1-bit code for a multi-bit input value.

Referring to FIG. 5, the PEB comprises two operation parts PEB-1 and PEB-2 having the same structure. Each of the operation parts comprises two 3-input XOR gates XOR0 and XOR1 (XOR2 and XOR3), a 32-bit adder/subtractor Adder/Subtractor0 (Adder/Subtractor1), a register Register0 (Register1), and a shifter Shifter0 (Shifter1). Each of the operation parts is used for processing data on an I channel and a Q channel. The PEB-1 is used for processing data on an I channel and the PEB-2 for processing data on a Q channel.

The PEB has eight input/output ports 0˜7 and two output ports 0˜1. The eight input/output ports comprise two East/West connection ports EW0 and EW1, two South/North connection ports SN0 and SN1, two PEA module ports PEA module0 and PEA module1, and two local memory ports LM0 and LM1. The two output ports comprise two ports to a transfer memory. The PEB can receive inputs from neighboring PEBs, a PEA module, or a local memory. Each of the operation parts PEB-1 and PEB-2 of the PEB is controlled by a PEB controller in the controller 100 shown in FIG. 1, and its output value is allocated to the output ports according to a control signal of the PEB controller.

Because the PEB comprises left and right operation parts that perform the same operation and have the same structure, only the left operation part PEB-1 will be described for simplicity. Although a description of the right operation part PEB-2 will not be given, it is equal to the description of the left operation part PEB-1.

Inputs from the neighboring PEBs, the PEA module, and the local memory can be applied to each of inputs IN0, IN1, IN4 and IN5 under the control of the PEB controller. The 3-bit XOR gates XOR0 and XOR1 mainly receive outputs of the PEA, perform an XOR operation on the contents of bits located in a particular position where there are output values of the CLFSR0 217 and CLFSR2 219 among output values of the PEA, and output the XOR result to the adder/subtractor Adder/Subtractor0. The Adder/Subtractor0 performs addition (or subtraction) on inputs 4 and 5 or outputs from the XOR gates XOR0 and XOR1, and stores the result therein. A correlation value, which is the addition/subtraction result from the Adder/Subtractor0, is output every symbol period. The Shifter0, a shifter for enabling bidirectional bit shifting, performs bit shifting on the output value of the Adder/Subtractor0. An output of the Shifter0 is a 32-bit result value comprising an output of the PEB.

Table 4 through Table 6 below show exemplary definitions of each control field and its operation of a PEB with the structures shown in FIG. 5. The operation of the PEB using the various control fields is controlled by a PEB controller (not shown) in the controller 100 shown in FIG. 1.

Table 4 below shows exemplary definitions of each operation control field and its operation of the PEB. An Adder0 (or Adder1) performs addition or subtraction on a value from a Register0 (or Register1) and an output value of a 3-bit XOR gate XOR0 (or XOR2) or an output value of a 3-bit XOR gate XOR1 (or XOR3) using bit numbers 0˜3. The Register0 (or Register1) initializes with 0, loads a new value input to the input/output port, or keeps the current value using bit numbers 4, 5, 6 and 7. A Shifter0 (or Shifter1), which is a shifter for performing bit shifting, can perform bit-by-bit shifting from the left 15 bits to the right 16 bits using bit numbers 8˜12 and 13˜17.

Table 5 below shows exemplary definitions of an input control field and its operation of the PEB. Each control value allocates eight input/output ports 0˜7 to each of ten inputs IN0˜IN9. That is, each of the ten inputs is connected to one of the eight input/output ports. Each of the eight input/output ports connects with a PEB neighboring in the East/West direction through two ports EW0 and EW1, connects with a PEB neighboring in the South/North direction through two ports SN0 and SN1, connects with two PEA module's input/output ports PEA Module 0 and PEA Module 1 of a PEA module connected to the corresponding PEB, and connects with a local memory of a PEAB block including the corresponding PEB through two ports LM0 and LM1.

Table 6 below shows exemplary definitions of an output control field and its operation of each PEB. Each of outputs Output0 and Output1 of the PEB includes outputs passing through eight input/output ports 0˜7 and outputs passing through two output ports 0˜1. Because the eight input/output ports and the two output ports remain in a Z (that is, high impedance) state when there is no output for Output0 (or Output1) of the PEB, only the ports having an output are enabled.

TABLE 4

| Bit number | FU | Bit value | Operation |
|---|---|---|---|
| 0 | Adder 0 | 0 | Add input 0 |
| | | 1 | Subtract input 0 |
| 1 | | 0 | Add input 1 |
| | | 1 | Subtract input 1 |
| 2 | Adder 1 | 0 | Add input 0 |
| | | 1 | Subtract input 0 |
| 3 | | 0 | Add input 1 |
| | | 1 | Subtract input 1 |
| 4, 5 | Register 0 | 00 | Reset |
| | | 01 | Load new value |
| | | 10 | Keep current value |
| 6, 7 | Register 1 | 00 | Reset |
| | | 01 | Load new value |
| | | 10 | Keep current value |
| 8, 9, 10, 11, 12 | Shifter 0 | 00000 | No Shift |
| | | 00001 | Right Shift by 1 |
| | | 00010 | Right Shift by 2 |
| | | 00011 | Right Shift by 3 |
| | | 00100 | Right Shift by 4 |
| | | 00101 | Right Shift by 5 |
| | | 00110 | Right Shift by 6 |
| | | 00111 | Right Shift by 7 |
| | | 01000 | Right Shift by 8 |
| | | 01001 | Right Shift by 9 |
| | | 01010 | Right Shift by 10 |
| | | 01011 | Right Shift by 11 |
| | | 01100 | Right Shift by 12 |
| | | 01101 | Right Shift by 13 |
| | | 01110 | Right Shift by 14 |
| | | 01111 | Right Shift by 15 |
| | | 10000 | Right Shift by 16 |
| | | 10001 | Left Shift by 1 |
| | | 10010 | Left Shift by 2 |
| | | 10011 | Left Shift by 3 |
| | | 10100 | Left Shift by 4 |
| | | 10101 | Left Shift by 5 |
| | | 10110 | Left Shift by 6 |
| | | 10111 | Left Shift by 7 |
| | | 11000 | Left Shift by 8 |
| | | 11001 | Left Shift by 9 |
| | | 11010 | Left Shift by 10 |
| | | 11011 | Left Shift by 11 |
| | | 11100 | Left Shift by 12 |
| | | 11101 | Left Shift by 13 |
| | | 11110 | Left Shift by 14 |
| | | 11111 | Left Shift by 15 |
| 13, 14, 15, 16, 17 | Shifter 1 | 00000 | No Shift |
| | | 00001 | Right Shift by 1 |
| | | 00010 | Right Shift by 2 |
| | | 00011 | Right Shift by 3 |
| | | 00100 | Right Shift by 4 |
| | | 00101 | Right Shift by 5 |
| | | 00110 | Right Shift by 6 |
| | | 00111 | Right Shift by 7 |
| | | 01000 | Right Shift by 8 |
| | | 01001 | Right Shift by 9 |
| | | 01010 | Right Shift by 10 |
| | | 01011 | Right Shift by 11 |
| | | 01100 | Right Shift by 12 |
| | | 01101 | Right Shift by 13 |
| | | 01110 | Right Shift by 14 |
| | | 01111 | Right Shift by 15 |
| | | 10000 | Right Shift by 16 |
| | | 10001 | Left Shift by 1 |
| | | 10010 | Left Shift by 2 |
| | | 10011 | Left Shift by 3 |
| | | 10100 | Left Shift by 4 |
| | | 10101 | Left Shift by 5 |
| | | 10110 | Left Shift by 6 |
| | | 10111 | Left Shift by 7 |
| | | 11000 | Left Shift by 8 |
| | | 11001 | Left Shift by 9 |
| | | 11010 | Left Shift by 10 |
| | | 11011 | Left Shift by 11 |
| | | 11100 | Left Shift by 12 |
| | | 11101 | Left Shift by 13 |
| | | 11110 | Left Shift by 14 |
| | | 11111 | Left Shift by 15 |

TABLE 5

| Bit number | Function Unit | Bit value | Selected Inout Port |
|---|---|---|---|
| 0, 1, 2, 3 | IN0 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 4, 5, 6, 7 | IN1 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 8, 9, 10, 11 | IN2 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 12, 13, 14, 15 | IN3 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 16, 17, 18, 19 | IN4 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 20, 21, 22, 23 | IN5 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 24, 25, 26, 27 | IN6 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 28, 19, 30, 31 | IN7 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 32, 33, 34, 35 | IN8 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |
| 36, 37, 38, 39 | IN9 | 0000 | No input |
| | | 0001 | EW0 |
| | | 0010 | EW1 |
| | | 0011 | SN0 |
| | | 0100 | SN1 |
| | | 0101 | PEA Module0 |
| | | 0110 | PEA Module1 |
| | | 0111 | LM0 |
| | | 1000 | LM1 |

TABLE 6

| Bit | | | |
|---|---|---|---|
| number | Inout or Output port | Bit value | Operation |
| 0 | EW0 (East/West 0) | 0 | No output |
| | | 1 | Output |
| 1 | EW1 (East/West 1) | 0 | No output |
| | | 1 | Output |
| 2 | SN0 (South/North 0) | 0 | No output |
| | | 1 | Output |
| 3 | SN1 (South/North 1) | 0 | No output |
| | | 1 | Output |
| 4 | PEA Module 0 | 0 | No output |
| | | 1 | Output |
| 5 | PEA Module 1 | 0 | No output |
| | | 1 | Output |
| 6 | LM0 (Local Memory 0) | 0 | No output |
| | | 1 | Output |
| 7 | LM1 (Local Memory 1) | 0 | No output |
| | | 1 | Output |
| 8 | TFM0 (Transfer Memory 0: output) | 0 | No output |
| | | 1 | Output |
| 9 | TFM1 (Transfer Memory 1: output) | 0 | No output |
| | | 1 | Output |

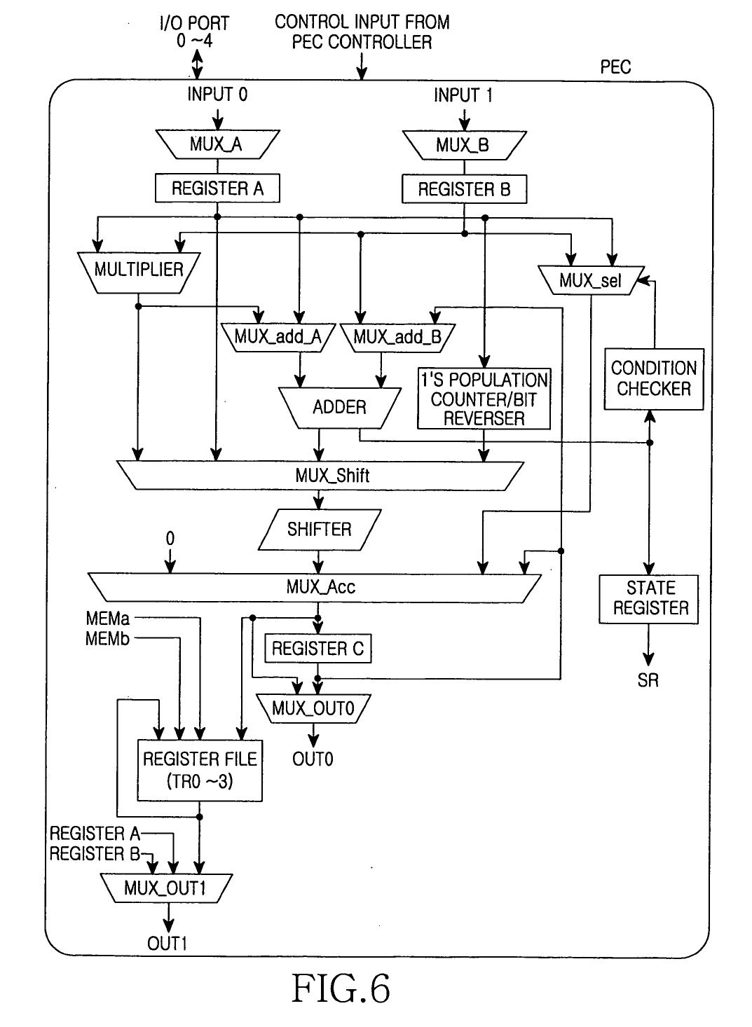

FIG. 6 is a diagram illustrating a configuration of a PEC among PEs according to an embodiment of the present invention. The PEC can comprise a PE that aims at performing a multiplier and accumulator (MAC) operation.

Referring to FIG. 6, the PEC comprises a 16-bit multiplier, a 32-bit adder, a 32-bit shifter, a condition checker, a 1's population counter (or bit reverser), a state register, a register file TR0˜TR3, and remaining registers and multiplexers (MUXs). The registers comprise Register A, Register B, and Register C. The multiplexers comprise MUX_A, MUX_B, MUX_add_A, MUX_add_B, MUX_Shift, MUX_sel, MUX_Acc, MUX_OUT0, and MUX_OUT1. The PEC comprises a total of five input/output ports 0˜4 of one PECD block port, one neighboring-PEC port in the East/West direction, one neighboring-PEC port in the South/North direction, and two local memory ports. The PEC performs its input control, output control and operation-related control upon receiving a control signal from a PEC controller. Each element of the PEC performs a certain operation for a given input values according to a control value of the PEC controller and outputs an operation result. The control value of the PEC controller for the each element of the PEC will not be described in detail.

Input0 and input1 are inputs from a local memory, internal registers, a neighboring PEC, and neighboring PECD blocks. The Input0 and input1 selected by the multiplexers MUX_A and MUX_B are delivered to the Register A and the Register B, respectively. An output of the Register A is delivered to inputs of the 16-bit multiplier, the MUX_shift and the MUX_add_A, the 32-bit adder, the 1's population counter/bit reverser, and the Register C. An output of the Register B is delivered to inputs of the 16-bit multiplier, and the MUX_add_B and the MUX_sel. The 16-bit multiplier performs multiplication on outputs of the Register A and the Register B. An output of the 16-bit multiplier is provided to an input of the 32-bit adder via the MUX_add_A, and is also provided to an input of the 32-bit shifter via the MUX_Shift. The 32-bit adder selects two outputs from among an output of the Register A and an output of the 16-bit multiplier, both passing through the MUX_add_A, and an output of the Register B and an output of the Register C, both passing through the MUX_add_B, and performs addition on the selected outputs. An output of the 32-bit adder is provided to the 32-bit shifter, the condition checker, and the state register via the MUX_Shift.

The 1's population counter/bit reverser performs as a counter that counts the number of 1s in a value of the Register A, also performs as a bit reverser for bit-reversing the value of the Register A. The operation of the 1's population counter/bit reverser is controlled according to a control value of the PEC controller. The 1's population counter/bit reverser provides the count or bit-reversing value to the 32-bit shifter via the MUX_Shift. The condition checker controls the MUX_sel such that one of the value of the Register A and the value of the Register B is provided to the Register C according to conditions of the output of the 32-bit adder, that is the output SR of the state register and the control value of the PEC controller (not shown).

The register file, which are a group of registers for temporarily storing data, is comprised of four registers TR0˜TR3. Each of the registers TR0˜TR3 can store one of an output value of the MUX_Acc, values MEMa and MEMb read from the local memory, and a value stored therein. The MUX_OUT1 outputs one of the output values of the Register A, the Register B and the register file. The MUX_OUT0 outputs one of the output values of the Register C and the MUX_Acc. Outputs OUT0 and OUT1 of the MUX_OUT0 and MUX_OUT1, which are two possible output results of the PEC, are 32-bit calculation result values.

Operations and their input/output-related control of the 16-bit multiplier, the 32-bit adder, the 32-bit shifter, the condition checker, the 1's population counter/bit reverser, the state register, the register file TR0˜TR3, and remaining registers and multiplexers, are controlled by the PEC controller (not shown) in the controller 100 shown in FIG. 1. Table 7 below shows exemplary definitions of each operation control field, input/output control field, and their operations of the PEC having the structure shown in FIG. 6.

TABLE 7

| Control Signals | Bit format | #Bits | Operations |
|---|---|---|---|
| OE_PB1 | <50> | 1 | Output enable for PBCD Block connection from |
| | | | OUT1 |
| MUX_Out1<2:0> | <49:47> | 3 | Specify MUX_Out1 input selection |
| Imm<7:0> | <46:39> | 8 | Immediate operand value |
| MUX_A<3> | <38> | 1 | Specify MUX_A input selection |
| MUX_B<3> | <37> | 1 | Specify MUX_B input selection |
| MUX_TR3<1:0> | <36:35> | 2 | Specify MUX_TR3 input selection |
| MUX_TR2<1:0> | <34:33> | 2 | Specify MUX_TR2 input selection |
| MUX_TR1<1:0> | <32:31> | 2 | Specify MUX_TR1 input selection |
| MUX_TR0<1:0> | <30:29> | 2 | Specify MUX_TR0 input selection |
| Pop | <28> | 1 | 1s population count/bit reverse |
| Cond<1:0> | <27:26> | 2 | Specify ACS(Add Compare Selection) condition |
| Reserved | <25:24> | 2 | Reserved Bits |
| MUX_add_A | <23> | 1 | Specify MUX_add_A input selection |
| MUX_add_B | <22> | 1 | Specify MUX_add_B input selection |
| MUX_shift<1:0> | <21:20> | 2 | Specify MUX_shift input selection |
| MUX_Acc<1:0> | <19:18> | 2 | Specify MUX_Acc input selection |
| subtract | <17> | 1 | Subtraction Control |
| Shift<6:0> | <16:10> | 7 | Shift amount |
| MUX_A<2:0> | <9:7> | 3 | Specify MUX_A input selection |
| MUX_B<2:0> | <6:4> | 3 | Specify MUX_B input selection |
| MUX_Out | <3> | 1 | Specify MUX_Out input selection |
| OE_PB | <2> | 1 | Output enable for connection to neighboring PECD |
| | | | Block |
| OE_PE0 | <1> | 1 | Output enable for connection to neighboring PEC0 |
| OE_PE1 | <0> | 1 | Output enable for connection to neighboring PEC1 |

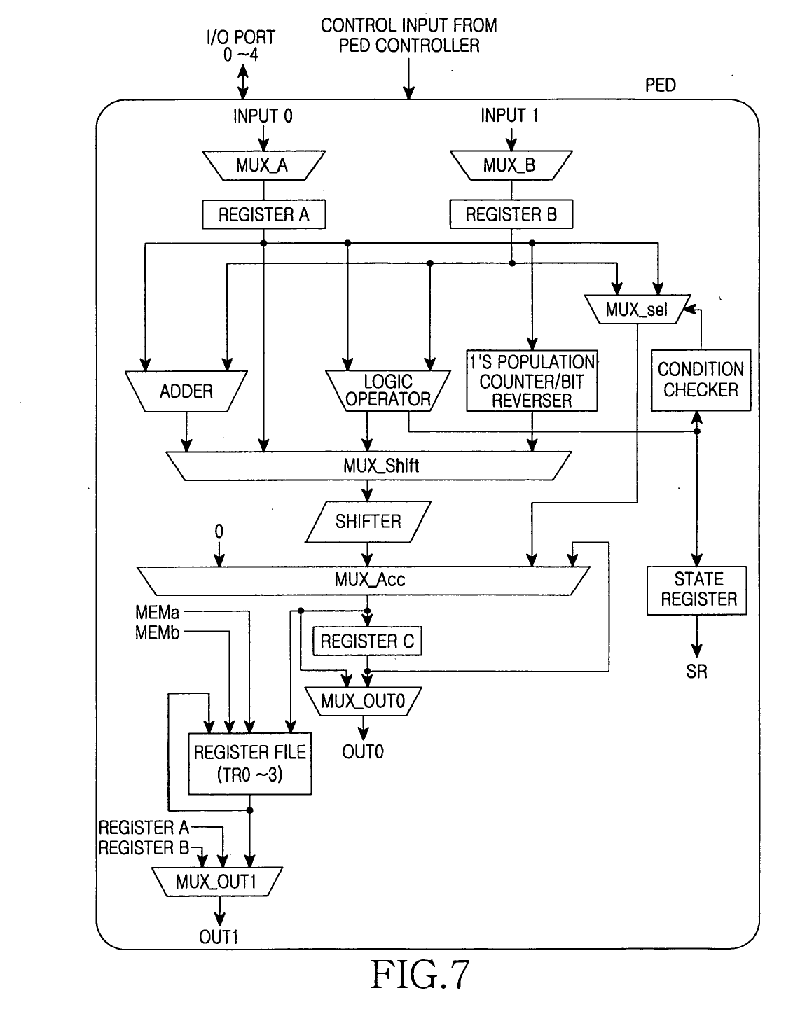

FIG. 7 is a diagram illustrating a configuration of a PED among PEs according to an embodiment to the present invention.

Referring to FIG. 7, the PED is similar in configuration to the PEC shown in FIG. 6, but is different in that the PED uses an adder and a logic operator in place of the multiplier and the adder of the PEC. The multiplication-related operation is performed by the PEC, and the logic calculation and addition operation is performed by the PED. Input/output ports of the PED comprise a total of five input/output ports 0˜4 of one PECD block port, one neighboring-PED port in the East/West direction, one neighboring-PED port in the South/North direction, and two local memory ports. The PED performs input control, output control and operation-related control under the control of a PED controller upon receiving a control signal from the PED controller.

The PED comprises a 32-bit logic operator, a 32-bit adder, a 32-bit shifter, a condition checker, a 1's population counter/bit reverser, a state register, a register file TR0˜TR3, and remaining registers and multiplexers (MUXs). Input0 and Input1 are inputs from a local memory, internal registers, a neighboring PED, and neighboring PECD blocks. The Input0 and input1 selected by the multiplexers MUX_A and MUX_B are delivered to the Register A and the Register B, respectively. An output of the Register A is delivered to inputs of the 32-bit adder, the 32-bit logic operator, the 1's population counter/bit reverser, the 32-bit shifter through the MUX-Shift and the Register C through the MUX_sel and the MUX_Acc. An output of the Register B is delivered to inputs of the 32-bit adder, the 32-bit logic operator, and the Register C through the MUX_sel and the MUX_Acc. The 32-bit adder performs addition on outputs of the Register A and the Register B. An output of the 32-bit adder is provided to the 32-bit shifter via the MUX_Shift. The 32-bit logic operator performs a logic operation on the outputs of the Register A and the Register B. The operation result of the 32-bit logic operator is provided to the 32-bit shifter, the condition checker and the state register D via the MUX_Shift.

The 1's population counter/bit reverser counts the number of Is in a value of the Register A, and provides the count value to the 32-bit shifter via the MUX_Shift. The 1's population counter/bit reverser also performs as a bit reverser. The condition checker controls the MUX_sel such that one of the value of the Register A and the value of the Register B is provided to the Register C according to conditions of the output of the 32-bit adder, that is the output SR of the state register and the control value of the PED controller (not shown). The register file, a group of registers for temporarily storing data, is comprised of four registers TR0˜TR3. Each of the registers TR0˜TR3 can store one of an output value of the MUX_Acc, values MEMa and MEMb read from the local memory, and a value stored therein. The MUX_OUT1 outputs one of the output values of the Register A, the Register B and the register file. The MUX_OUT0 outputs one of the output values of the Register C and the MUX_Acc. Outputs OUT0 and OUT1 of the MUX_OUT0 and MUX_OUT1, which are two possible output results of the PED, are 32-bit calculation result values.

Operations and their input/output-related control of the 32-bit adder, the 32-bit logic operator, the 32-bit shifter, the condition checker, the 1's population counter/bit reverser, the state registers, the register file TR0˜TR3, and remaining registers and multiplexers are controlled by the PED controller (not shown) in the controller 100 shown in FIG. 1. Table 8 below shows exemplary definitions of each operation control field, input/output control field, and their operations of the PED having the structure shown in FIG. 7.

TABLE 8

| Control Signals | Bit format | #Bits | Operations |
|---|---|---|---|
| OE_PB1 | <50> | 1 | Output enable for PBCD Block connection from |
| | | | OUT1 |
| MUX_Out1<2:0> | <49:47> | 3 | Specify MUX_Out1 input selection |
| Imm<7:0> | <46:39> | 8 | Immediate operand value |
| MUX_A<3> | <38> | 1 | Specify MUX_A input selection |
| MUX_B<3> | <37> | 1 | Specify MUX_B input selection |
| MUX_TR3<1:0> | <36:35> | 2 | Specify MUX_TR3 input selection |
| MUX_TR2<1:0> | <34:33> | 2 | Specify MUX_TR2 input selection |
| MUX_TR1<1:0> | <32:31> | 2 | Specify MUX_TR1 input selection |
| MUX_TR0<1:0> | <30:29> | 2 | Specify MUX_TR0 input selection |
| Pop | <28> | 1 | 1s population count/bit reverse |
| Cond<1:0> | <27:26> | 2 | Specify ACS(Add Compare Selection) condition |
| Logic_func<3:0> | <25:22> | 4 | Specify Logic function |
| MUX_shift<1:0> | <21:20> | 2 | Specify MUX_shift input selection |
| MUX_Acc<1:0> | <19:18> | 2 | Specify MUX_Acc input selection |
| Sub | <17> | 1 | Subtract |
| Shift<6:0> | <16:10> | 7 | Specify Shift operation |
| MUX_A<2:0> | <9:7> | 3 | Specify MUX_A input selection |
| MUX_B<2:0> | <6:4> | 3 | Specify MUX_B input selection |
| MUX_Out0 | <3> | 1 | Specify MUX_Out0 input selection |
| OE_PB | <2> | 1 | Output enable for connection to neighboring PECD |
| | | | Block |
| OE_PE0 | <1> | 1 | Output enable for connection to neighboring PED0 |
| OE_PE1 | <0> | 1 | Output enable for connection to neighboring PED1 |

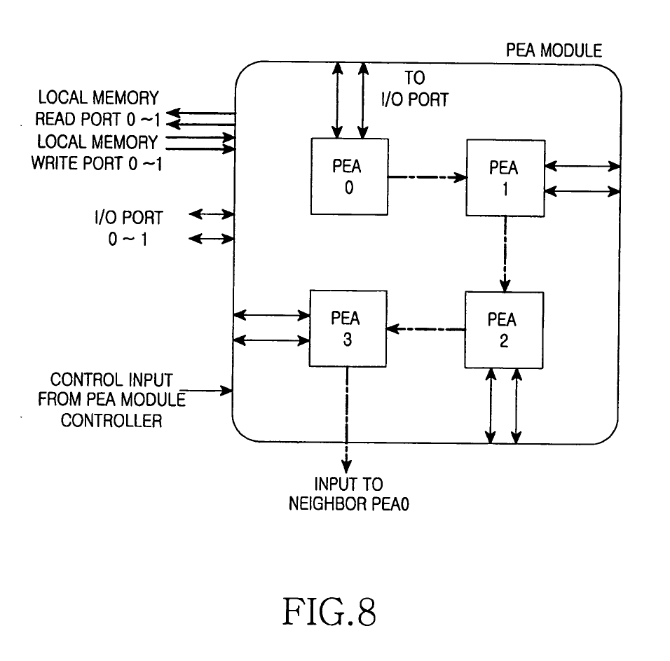

FIG. 8 is a diagram illustrating a configuration of a PEA module according to an embodiment of the present invention, in which the PEA module comprises four PEAs PEA0˜PEA3 by way of example.

Referring to FIG. 8, an exemplary connection direction between PEAs is possible only for a unidirectional connection (denoted by a dot-dash line) in the order of PEA0→PEA1→PEA2→PEA3 without being reconfigured. The PEA3 has a possible connection with only a PEA0 of a neighboring PEA module.

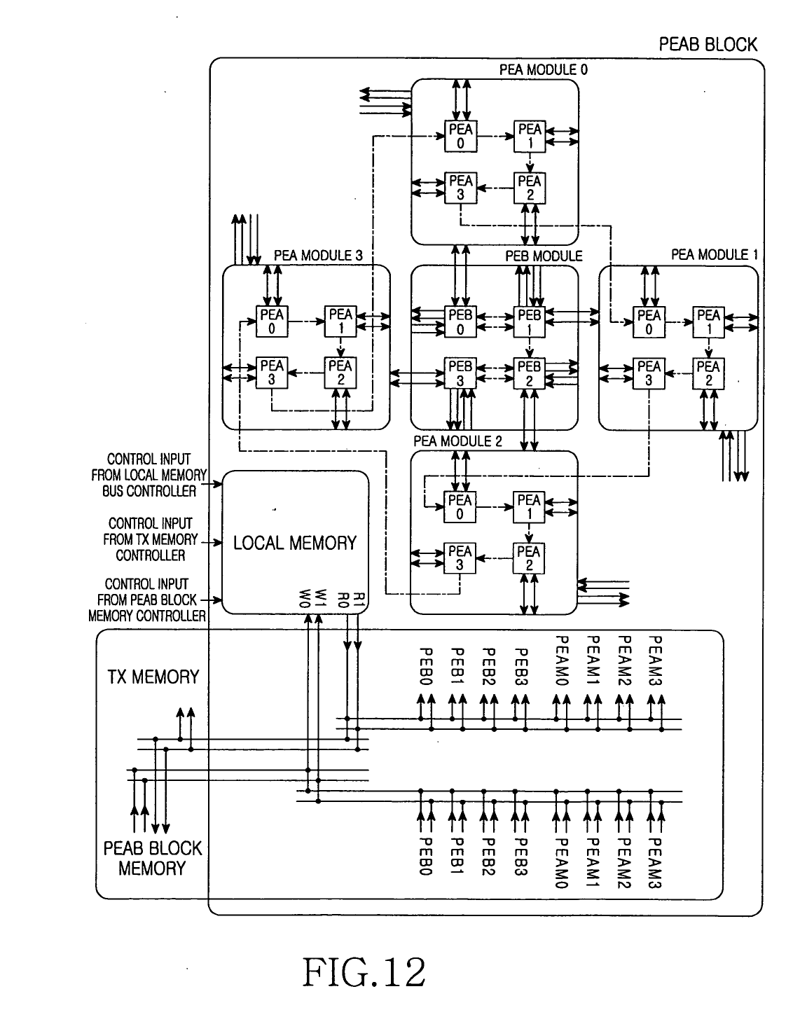

One PEA module can implement a CLFSR of a maximum of 20 bits by connecting 5-bit CLFSRs of its individual PEAs. The PEA module has two input/output ports 0˜1. Because the input/output ports are connected to input/output ports of PEAs in the PEA module and are externally connected to the PEB, data transmission/reception between the PEA and the PEB is performed by this connection (see FIG. 12). Further, because there are input ports (WRITE ports) 0˜1 and output ports (READ ports) 0˜1 to two individual local memories, data transmission/reception between the PEA and the local memories is performed by the input/output ports (see FIG. 12). Routing of the input/output ports is controlled according to a control signal generated by a PEA module controller (not shown) of the controller 100 shown in FIG. 1.

Table 9 below shows exemplary definitions of an input/output control field and its operation of a PEA module having the structure shown in FIG. 8. The operation of the PEA module using the various control fields is controlled by a PEA module controller (not shown) in the controller 100 shown in FIG. 1.

In Table 9, IDLE indicates that there is no input/output from the PEA, OUT_PEB indicates activation of an operation of transmitting outputs from input/output ports of the PEA to the PEB connected to the PEA, and IN_PEB indicates activation of an input from the PEB to the PEA's input/output ports. In addition, OUT_LM indicates activation of an operation of transmitting outputs from the input/output ports of the PEA to a corresponding local memory, and IN_LM indicates activation of an input from a corresponding local memory to the PEA's input/output ports.

TABLE 9

| | Bit | # | |
|---|---|---|---|
| Definition | Format | Bits | Operation |
| IDLE | <4> | 1 | No input or output from PEA |
| OUT_PEB | <3> | 1 | PEA's inout ports transmit the outputs to |
| | | | PEB |
| IN_PEB | <2> | 1 | PEA's inout ports receive the inputs from |
| | | | PEB |
| OUT_LM | <1> | 1 | PEA's inout ports transmit the outputs to |
| | | | Local Memory |
| IN_LM | <0> | 1 | PEA's inout ports receive the inputs from |
| | | | Local Memory |

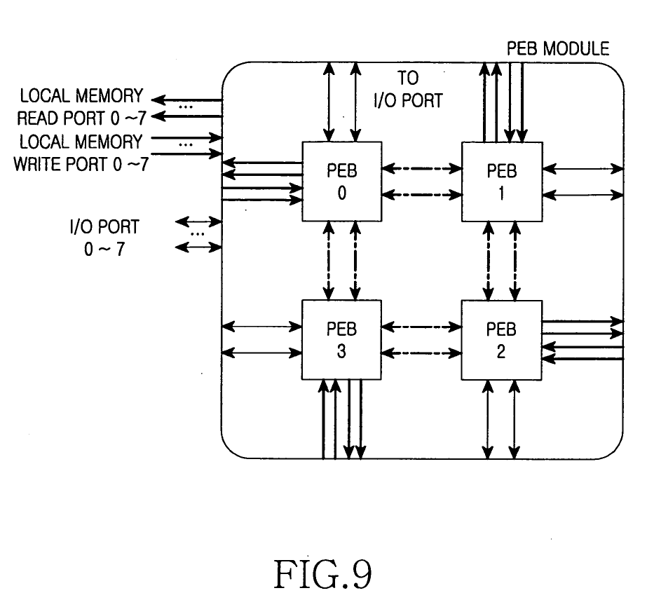

FIG. 9 is a diagram illustrating a configuration of a PEB module according to an embodiment of the present invention, in which the PEB module comprises four PEBs PEB0˜PEB3 by way of example.

Referring to FIG. 9, a routing line (denoted by a dot-dash line) that is reconfigurable by a PEB module controller exists between PEBs of the PEB module. Each PEB has connections to neighboring PEBs in the East/West direction and the South/North direction. This is to enable simultaneous data transmission over an I channel and a Q channel and two connections are possible in each connection direction. The PEB module does not take part in data transmission/reception between the local memory and the PEA modules, and the PEB directly manages the connections between the local memory and the PEA modules. Each PEB has its routing line for data transmission/reception over the I channel and the Q channel. Routing of the PEB is controlled by the respective PEB controller. Each PEB is controlled by its associated PEB controller. The PEB controller performs routing control, and enabling/addressing control required during a read/write operation between local memories.

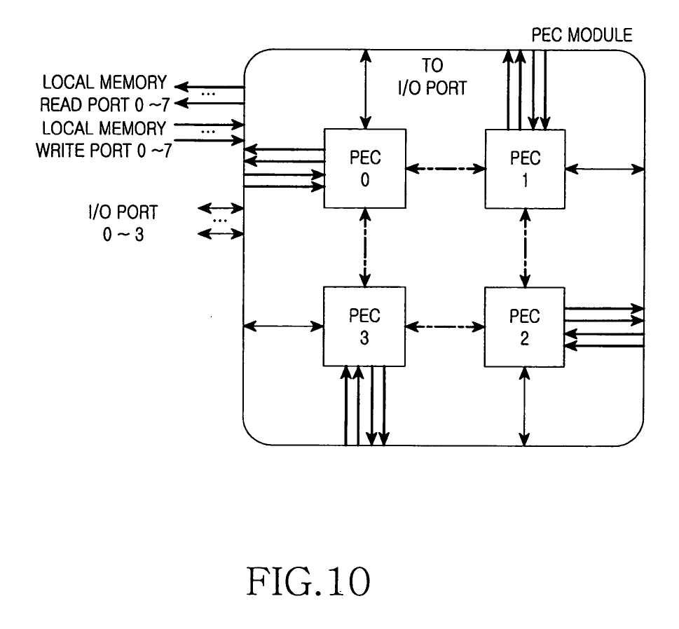

FIG. 10 is a diagram illustrating a configuration of a PEC module according to an embodiment of the present invention, in which the PEC module comprises four PECs PEC0˜PEC3.

Referring to FIG. 10, a routing line (denoted by a dot-dash line) that is reconfigurable by a PEC controller exists between PECs of the PEC module. Each PEC can be used for data transmission/reception with a predetermined PED module, and is also possible to access each local memory via two READ/WRITE ports 0˜7. Routing of the PEC is controlled by the respective PEC controller, and each PEC is controlled by its associated PEC controller. The PEC controller performs routing control, and enabling/addressing control required during a read/write operation between local memories.

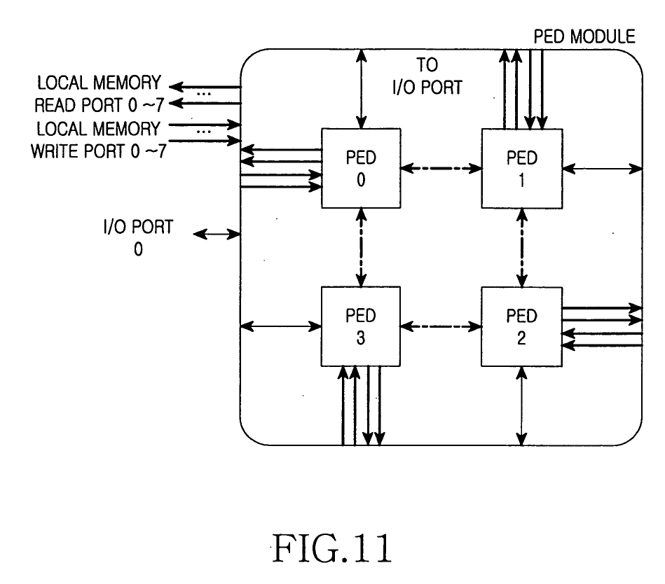

FIG. 11 is a diagram illustrating a configuration of a PED module according to an embodiment of the present invention, in which the PED module comprises four PEDs PED0˜PED3.

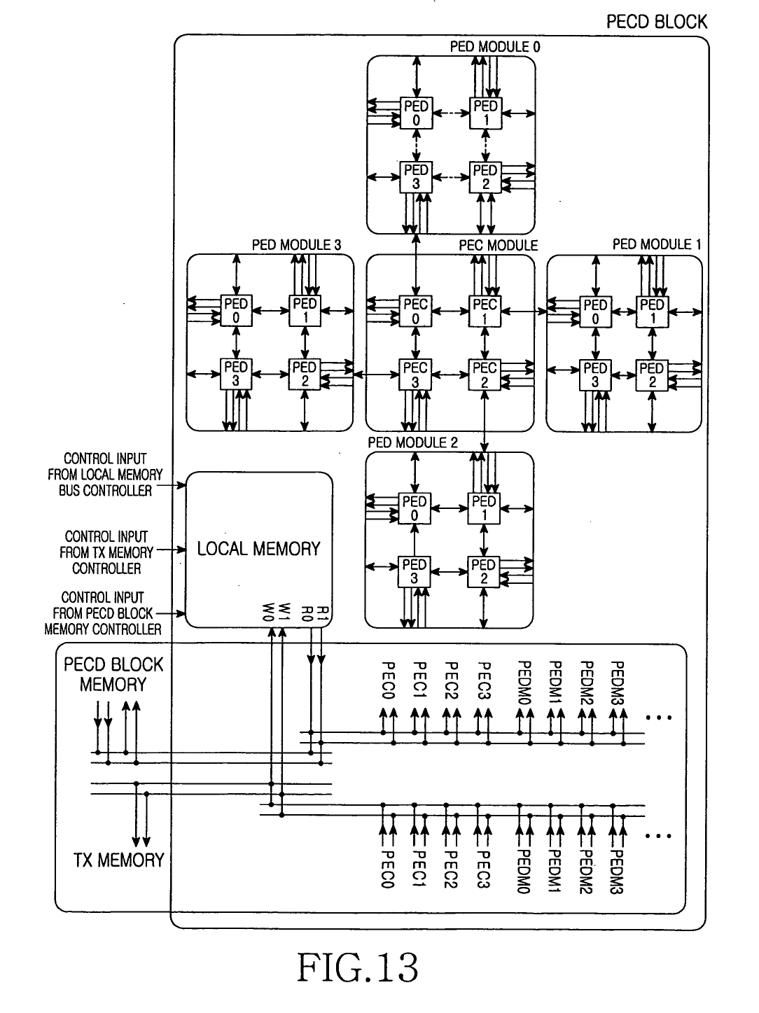

Referring to FIG. 11, the PED module has one input/output port (Input/Output Port0), and the Input/Output Port0 can connect with an input/output port of one of the four PEDs. Each PED is connected to a predetermined PEC via the PED module, and access to each local memory is achieved through two READ/WRITE ports 0˜7 (see FIG. 13). Routing of the PED is controlled by the respective PED controller, and each PED is controlled by its associated PED controller. The PED controller performs routing control, and enabling/addressing control required during a read/write operation between local memories.

FIG. 12 is a diagram illustrating a configuration of a PEAB block according to an embodiment of the present invention.

Referring to FIG. 12, the PEAB block comprises four PEA modules PEA Module0˜PEA Module3, one PEB module, and a local memory. The PEAB block exchanges data with another PEAB block or a transfer memory through the local memory. Each of the four PEA modules and each individual PEB in the PEB module access the local memory or the external transfer memory through two READ/WRITE ports.

In the process of performing access to the local memory and the transfer memory, an enable/address control signal is generated by a controller corresponding to the PEA modules and PEB for performing the access. The local memory serves as a buffer for external-outputting the PEAB block data and inputting external data to the PEAB block. An input/output interface has two READ ports and two WRITE ports, and an enabling/addressing control operation related to reading/writing is achieved by a controller for the devices (that is, PEA module, each PEB, and transfer memory) for accessing the local memory. A stored data width of the memory also has a 32-bit width like the data width.

FIG. 13 is a diagram illustrating a configuration of a PECD block according to an embodiment of the present invention.

Referring to FIG. 13, the PECD block comprises four PED modules PED Module0˜PED Module3, one PEC module, and a local memory. The PECD block exchanges data with another PECD block or a transfer memory through the local memory. All PEDs of the PED modules and all PECs of the PEC module access the local memory or the external transfer memory through two READ/WRITE ports.

In the process of performing an access to the local memory and the transfer memory, an enable/address control signal is generated by a controller corresponding to the PECs and PEDs for performing the access. A PEC0, a PEC1, a PEC2 and a PEC3 have bidirectional connections to PED Module0, PED Module1, PED Module2, and PED Module3, respectively. The local memory serves as a buffer for external-outputting of the PECD block data and inputting external data to the PECD block. An input/output interface has two READ ports and two WRITE ports, and an enabling/addressing control operation related to reading/writing is achieved by a controller for the devices (that is, each PEC, each PED, and transfer memory) for accessing the local memory. While the PEAB block's local memories are accessible only in the PEA module, the PECD block's local memories are accessible in each PED. A stored data width of the memory also has a 32-bit width like the data width.

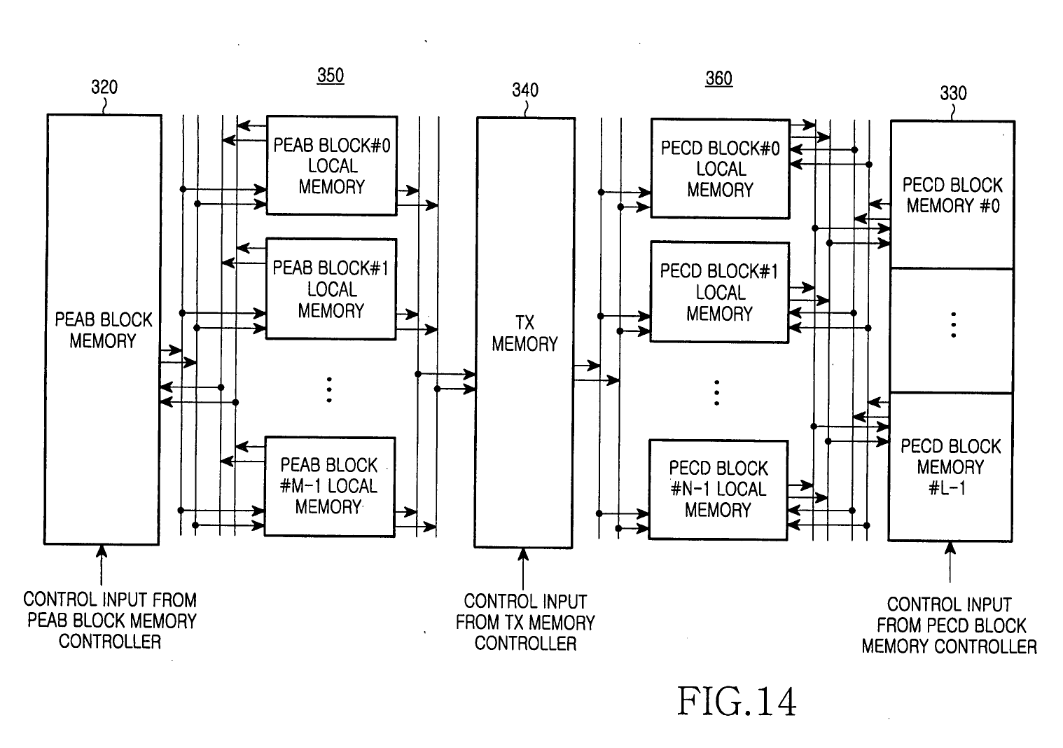

FIG. 14 is a diagram illustrating an exemplary interconnection for data transmission between a global memory and PE blocks according to an embodiment of the present invention. Specifically, FIG. 14 illustrates an interconnection for data transmission between a PEAB block memory 320, a PECD block memory 330 and a transfer memory 340, constituting a global memory, and a PEAB block's local memories 350 and a PECD block's local memories 360, constituting a PE block.

Referring to FIG. 14, the PE block's local memories 350 and 360 perform data transmission either between the same-type block's local memories, or with the transfer memory. The local memories 350 and 360, and the transfer memory 340 each have two READ/WRITE ports. The PEAB local memories 350 can perform both read and write operations with the PEAB block memory 320, but can perform only the write operation with the transfer memory 340. The PECD local memories 360 can perform both the read and write operations with the PECD block memory 330, but can perform only the read operation with the transfer memory 340. An enable signal and an address signal required by the transfer memory 340 for controlling the read/write operations from/into the PE block's local memories 350 and 360 are generated by a transfer memory controller.

The PEAB block memory 320, the PECD block memory 330 and the transfer memory 340 comprise a global memory. The PECD block memory 330 has “L” memory channels, and each channel's memory comprises two memory banks. Each memory bank has two READ/WRITE ports. The global memory comprised of the three memories 320, 330 and 340 has its associated controller, and the controller generates an enable signal and read/write address signals for the read/write operation of the global memory. A PECD block memory controller generates the enable signal and the address signal, and also generates a signal used for selecting a memory channel and a memory bank of the PECD block memory 330.

The PEAB block memory 320 is used for data transmission with M PEAB block's local memories 350, and is controlled by the PEAB block memory controller. Table 10 below shows exemplary control information and control signals generated by the PEAB block memory controller.

Enable signals and address signals are used for a read/write operation from/into the memory. Two enable signals en_csm_r0,r1,w0,w1 for each reading/writing are used for enabling the PEAB block memory 320, and 2*N enable signals en_ab_r0,r1,w0,w1 for each reading/writing are used for enabling the M PEAB block's local memories 350. In addition, address signals addr_csm_r0,r1,w0,w1 for the PEAB block memory 320, for indicating a corresponding memory position, and address signals addr_ab_r0,r1,w0,w1 for the M PEAB block's local memories 350, are used to perform the read/write operation.

The transfer memory 340 is used for data transmission with the M PEAB block's local memories 350 and the N PECD block's local memories 360, and is controlled by the transfer memory controller. Table 11 below shows exemplary control information and control signals generated by the transfer memory controller. Two enable signals en_tfm_r0,r1,w0,w1 for each reading/writing are used for enabling the transfer memory 340, 2*M enable signals en_ab_r0,r1[M] for enabling the M PEAB block's local memories 350 are used for performing the read operation, and 2*N enable signals en_cd_w0,w1[N] for enabling the N PECD block's local memories 360 are used for performing the write operation. In addition, address signals addr_tfm_r0,r1,w0,w1 for the transfer memory 340, for indicating a corresponding memory position, are used for performing reading/writing, address signals addr_ab_r0,r1[M] for the M PEAB block's local memories 350 are used for the read function, and address signals addr_cd_w0,w1[N] for the N PECD block's local memories 360 are used for the write function.

The PECD block memory 330 is comprised of 2*L memory banks and is used for data transmission with the N PECD local memories 360, and its channel bank selection operation and enabling/addressing operation are controlled by the PECD block memory controller. Table 12 below shows exemplary control information and control signals generated by the PECD block memory controller. Enable signals and address signals are used for a read/write operation from/into the memory. Two enable signals en_rvm_r0,r1,w0,w1 for each reading/writing are used for enabling the PECD block memory 330, and 2*N enable signals en_cd_r0,r1,w0,w1 for each reading/writing are used for enabling the N PECD block's local memories 360. In addition, address signals addr_rvm_r0,r1,w0,w1 for the PECD block memory 330, for indicating a corresponding memory position, and address signals addr_cd_r0,r1,w0,w1[N] for the N PECD block's local memories 360, are used to perform the read/write operation. Further, channel selection signals sel_ch_r,w and bank selection signals sel_bank_r,w are provided for selecting memory channel and bank.

TABLE 10

| Control | | |
|---|---|---|
| information | Control signal | Destination |
| Enable | En_csm_r0 | PEAB block memory |
| | En_csm_r1 | |
| | En_csm_w0 | |
| | En_csm_w1 | |
| | En_ab_r0 [M] | PEAB block's local |
| | En_ab_r1 [M] | memory |
| | En_ab_w0 [M] | |
| | En_ab_w1 [M] | |
| Address | addr_csm_r0 | PEAB block memory |
| | addr_csm_r1 | |
| | addr_csm_w0 | |
| | addr_csm_w1 | |
| | addr_ab_r0 [M] | PEAB block's local |
| | addr_ab_r1 [M] | memory |
| | addr_ab_w0 [M] | |
| | addr_ab_w1 [M] | |

TABLE 11

| Control | | |
|---|---|---|
| information | Control signal | Destination |
| Enable | En_tfm_r0 | Transfer memory |
| | En_tfm_r1 | |
| | En_tfm_w0 | |
| | En_tfm_w1 | |
| | En_ab_r0 [M] | PEAB block's local |
| | En_ab_r1 [M] | memory |
| | En_cd_w0 [N] | PECD block's local |
| | En_cd_w1 [N] | memory |
| Address | addr_tfm_r0 | Transfer memory |
| | addr_tfm_r1 | |
| | addr_tfm_w0 | |
| | addr_tfm_w1 | |
| | addr_ab_r0 [M] | PEAB block's local |
| | addr_ab_r1 [M] | memory |
| | addr_cd_w0 [N] | PECD block's local |
| | addr_cd_w1 [N] | memory |

TABLE 12

| Control | | |
|---|---|---|
| information | Control signal | Destination |
| Enable | en_rvm_r0 | PECD block memory |
| | en_vrm_r1 | |
| | en_rvm_w0 | |
| | en_rvm_w1 | |
| | en_cd_r0 [N] | PECD block's local |
| | en_cd_r1 [N] | memory |
| | en_cd_w0 [N] | |
| | en_cd_w1 [N] | |
| Address | addr_rvm_r0 | PECD block memory |
| | addr_vrm_r1 | |
| | addr_rvm_w0 | |
| | addr_rvm_w1 | |
| | addr_cd_r0 [N] | PECD block's local |
| | addr_cd_r1 [N] | memory |
| | addr_cd_w0 [N] | |
| | addr_cd_w1 [N] | |
| Channel selection | Sel_ch_r | PECD block memory |
| | Sel_ch_w | |
| Bank selection | Sel_bank_r | PECD block memory |
| | Sel_bank_w | |

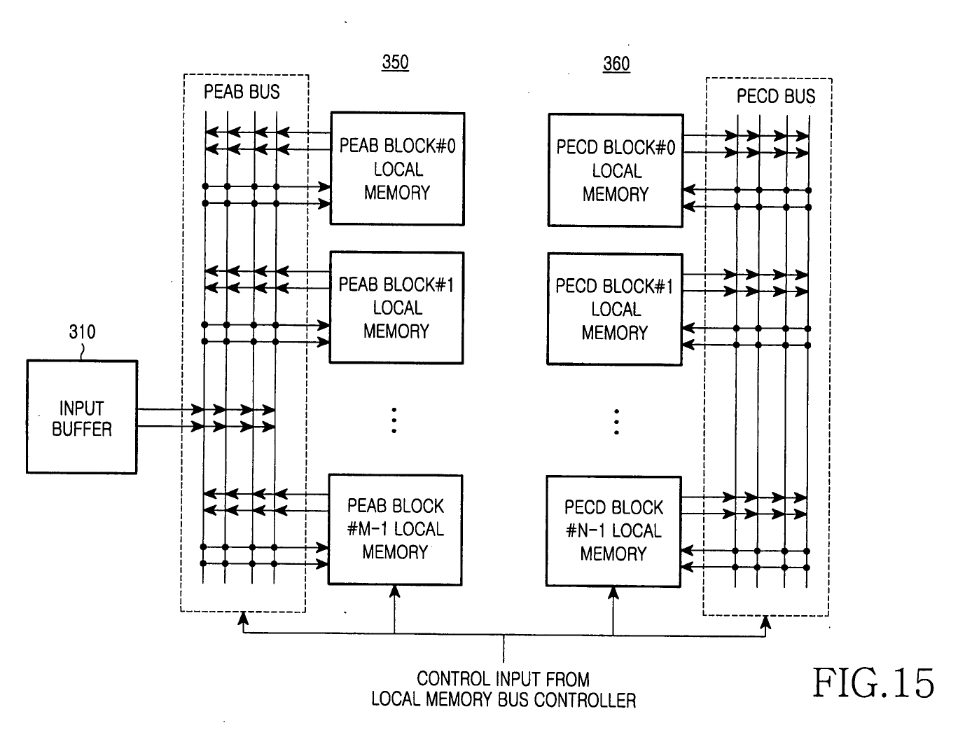

FIG. 15 is a diagram illustrating an exemplary interconnection between an input buffer 310, PEAB block's local memories 350, and PECD block's local memories 360 according to an embodiment of the present invention.

Referring to FIG. 15, in an exemplary embodiment, data transmission is possible only between the same-type PE blocks' local memories, and this is achieved through local memory buses PEAB Bus and PECD bus. The input buffer 310 is connected to the PEAB block's local memories 350.

There are four local memory buses provided in the PEAB Bus for data transmission between PEAB blocks, and there are four local memory buses provided in the PECD Bus for data transmission between PECD blocks. The local memory buses are controlled by a local memory bus controller. Control signals include bus selection signals, enable signals and read/write address signals, used by a local memory to access the local memory buses. The bus selection signals are used for selecting one of the four PEAB bus lines used by the local memory buses for data reading/writing, and the enable signals are used for enabling the selected bus. The address signals indicate a data read/write position in the corresponding PEAB block or PECD block's local memories.

The input buffer 310 is connected to the PEAB Bus, and its output is controlled by the local memory bus controller. Table 13 below shows exemplary control information and control signals generated by the local memory bus controller. The following bus selection signals are provided, including sel_bus_ab_w0,w1,r0,r1[M] and sel_bus_cd_w0,w1,r0,r1[N] for selecting the PEAB Bus and the PECD Bus, enable signals en_ab_w0,w1,r0,r1[M] and en_cd_w0,w1,r0,r1[N] for enabling the PEAB Bus and the PECD Bus, and address signals addr_ab_w0,w1,r0,r1[M] and addr_cd_w0,w1,r0,r1[N] for indicating data storage positions in the M PEAB block's local memories 350 and the N PECD block's local memories 360.

The input buffer 310 is a data inputting/storing space having two input ports and two output ports. The individual input ports are used for receiving input data on an I arm and a Q arm, respectively. The input buffer stores input data from the external hardware, and transmits the input data to the PEAB block's local memories.

TABLE 13

| Control | | | |
|---|---|---|---|
| information | Control signal | | Destination |
| Bus selection | PEAB block | sel_bus_ab_w0[M] | PEAB bus |
| | | sel_bus_ab_w1[M] | |
| | | sel_bus_ab_r0[M] | |
| | | sel_bus_ab_r0[M] | |
| | PECD block | sel_bus_cd_w0[N] | PECD bus |
| | | sel_bus_cd_w1[N] | |
| | | sel_bus_cd_r0[N] | |
| | | sel_bus_cd_r0[N] | |
| Enable | PEAB block | en_ab_w0[M] | PEAB bus |
| | | en_ab_w1[M] | |
| | | en_ab_r0[M] | |
| | | en_ab_r0[M] | |
| | PECD block | en_cd_w0[N] | PECD bus |
| | | en_cd_w1[N] | |
| | | en_cd_r0[N] | |
| | | en_cd_r0[N] | |
| | Input buffer | en_ib0 | PEAB bus |
| | | en_ib1 | |
| Address | PEAB block | addr_ab_w0[M] | PEAB block's local |
| | | addr_ab_w1[M] | memory |
| | | addr_ab_r0[M] | |
| | | addr_ab_r0[M] | |
| | PECD block | addr_cd_w0[N] | PECD block's local |
| | | addr_cd_w1[N] | memory |
| | | addr_cd_r0[N] | |
| | | addr_cd_r0[N] | |

As can be understood from the foregoing description, embodiments of the present invention provide a reconfigurable hardware structure in which multiple wireless transmission standards are taken into consideration, thereby making it possible to modify the existing function and add new functions through hardware reconfiguration. In addition, embodiments of the present invention provide higher implementation flexibility in adding a new wireless transmission standard.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A communication system having a reconfigurable hardware structure, comprising:
a plurality of processing element (PE) blocks for processing data based on multiple wireless transmission standards;
a plurality of memories for storing data being processed or to be processed by the PE blocks; and
a controller for controlling data processing in the PE blocks, a data input operation to the PE blocks and a data output operation from the PE blocks, and for controlling transmission of data being processed in and input/output to/from the PE blocks;
wherein each of the PE blocks comprises a plurality of PE modules, and each of the PE modules comprises a predetermined number of PEs that perform different functions, and wherein an operation and input/output of the PE blocks, the PE modules and the PEs are controlled by the controller.

2. The communication system of claim 1, wherein the PEs are configured to support a wireless transmission standard of code division multiple access 2000 (CDMA2000) or wideband code division multiple access (WCDMA).

3. The communication system of claim 1, wherein each of the PE modules comprises:
a first module comprising a predetermined number of PEs that perform a bit-by-bit operation;
a second module comprising a predetermined number of PEs that perform a correlation operation on multi-bit input data;
a third module comprising a predetermined number of PEs that perform a multiplication and accumulation operation; and
a fourth module comprising a predetermined number of PEs that perform an addition and logic calculation operation.

4. The communication system of claim 3, wherein the first-module PEs are configured to serve as a code generator.

5. The communication system of claim 4, wherein the first module comprises dual-structured PEs that are configured to perform the same operation.

6. The communication system of claim 3, wherein the second module comprises dual-structured PEs that are configured to perform the same operation.

7. The communication system of claim 3, wherein each of the modules comprises four PEs.

8. The communication system of claim 1, wherein each of the memories comprises:
an input buffer for storing input data;
a local memory for storing data processed in the PE blocks; and
a global memory for storing data input to the PE blocks and data output from the PE blocks.

9. The communication system of claim 8, wherein the global memory comprises:
a transfer memory for storing data transmitted between the PE blocks; and
a block memory for storing data input to the PE blocks and data output from the PE blocks.

10. A communication system having a reconfigurable hardware structure, comprising:
first and second processing element (PE) blocks for processing data based on multiple wireless transmission standards;
an input buffer for storing input data;
a first block memory for storing data being processed or to be processed by the first PE block;
a second block memory for storing data being processed or to be processed by the second PE block;
a transfer memory for storing data transmitted between the first PE block and the second PE block; and
a controller for controlling data processing in the first and second PE blocks, a data input operation to the first and second PE blocks and a data output operation from the first and second PE blocks, and for controlling transmission of data being processed in and input/output to/from the first and second PE blocks;
wherein each of the first and second PE blocks comprises one or more PE modules, and each of the PE modules comprises a predetermined number of PEs that perform different functions, and wherein an operation and input/output of the first and second PE blocks, the PE modules and the PEs are controlled by the controller.

11. The communication system of claim 10, wherein the PEs are configured to support a wireless transmission standard of code division multiple access 2000 (CDMA2000) or wideband code division multiple access (WCDMA).

12. The communication system of claim 10, wherein the first PE block comprises:
at least one first module comprising a predetermined number of PEs that perform a bit-by-bit operation; and
a second module comprising a predetermined number of PEs that perform a correlation operation on multi-bit input data.

13. The communication system of claim 12, further comprising a local memory for storing data processed in the first and second modules.

14. The communication system of claim 12, wherein the first-module PEs serve as a code generator.

15. The communication system of claim 12, wherein the first module comprises dual-structured PEs that perform the same operation.

16. The communication system of claim 12, wherein the second module comprises dual-structured PEs that perform the same operation.

17. The communication system of claim 12, wherein each of the modules comprises four PEs.

18. The communication system of claim 10, wherein the second PE block comprises:
a third module comprising a predetermined number of PEs that perform a multiplication and accumulation operation; and
at least one fourth module comprising a predetermined number of PEs that perform an addition and logic calculation operation.

19. The communication system of claim 18, further comprising a local memory for storing data processed in the third and fourth modules.

20. The communication system of claim 18, wherein each of the modules comprises four PEs.

21. A method for reconfiguring a communication system, comprising the steps of:
configuring a plurality of processing element (PE) blocks for processing data based on multiple wireless transmission standards, and configuring memories for storing data being processed or to be processed by the PE blocks;
configuring a controller for controlling data processing in the PE blocks, a data input operation to the PE blocks and a data output operation from the PE blocks, and for controlling transmission of data being processed in and input/output to/from the PE blocks;
configuring each of the PE blocks with a plurality of PE modules, and configuring each of the PE modules with a predetermined number of PEs that perform different functions; and
reconfiguring functions of the PEs by controlling operation and input/output of the PE blocks, the PE modules and the PEs using the controller.

22. The method of claim 21, wherein the PEs are configured to support a wireless transmission standard of code division multiple access 2000 (CDMA2000) or wideband code division multiple access (WCDMA).

23. The method of claim 21, wherein the step of configuring each of the PE modules with a predetermined number of PEs comprises the steps of:
configuring each of the PE modules with a first module comprising the predetermined number of PEs that perform a bit-by-bit operation;
configuring a second module comprising the predetermined number of PEs that perform a correlation operation on multi-bit input data;
configuring a third module comprising the predetermined number of PEs that perform a multiplication and accumulation operation; and
configuring a fourth module comprising the predetermined number of PEs that perform an addition and logic calculation operation.

24. The method of claim 23, wherein the controller uses the first-module PEs as a code generator.

25. The method of claim 24, wherein the first module comprises dual-structured PEs that perform the same operation.

26. The method of claim 23, wherein the second module comprises dual-structured PEs that perform the same operation.

27. The method of claim 23, wherein each of the modules comprises four PEs.

28. A method for reconfiguring a communication system, comprising the steps of:
configuring first and second processing element (PE) blocks for processing data based on multiple wireless transmission standards;
configuring an input buffer for storing input data;
configuring a first block memory for storing data being processed or to be processed by the first PE block;
configuring a second block memory for storing data being processed or to be processed by the second PE block;
configuring a transfer memory for storing data transmitted between the first PE block and the second PE block;
configuring a controller for controlling data processing in the first and second PE blocks, a data input operation to the first and second PE blocks and a data output operation from the first and second PE blocks, and for controlling transmission of data being processed in and input/output to/from the first and second PE blocks;
configuring each of the first and second PE blocks with one or more PE modules, and configuring each of the PE modules with a predetermined number of PEs that perform different functions; and
reconfiguring functions of the PEs by controlling operation and input/output of the first and second PE blocks, the PE modules and the PEs using the controller.

29. The method of claim 28, wherein the PEs are configured to support a wireless transmission standard of code division multiple access 2000 (CDMA2000) or wideband code division multiple access (WCDMA).

30. The method of claim 28, wherein the step of configuring the first PE block with a predetermined number of PE modules comprises the steps of:
configuring the first PE block with at least one first module comprising the predetermined number of PEs that perform a bit-by-bit operation; and
configuring a second module comprising the predetermined number of PEs that perform a correlation operation on multi-bit input data.

31. The method of claim 30, further comprising the step of configuring a local memory for storing data processed in the first and second modules.

32. The method of claim 30, wherein the controller uses the first-module PEs as a code generator.

33. The method of claim 30, wherein the first module comprises dual-structured PEs that perform the same operation.

34. The method of claim 30, wherein the second module comprises dual-structured PEs that perform the same operation.

35. The method of claim 30, wherein each of the modules comprises four PEs.

36. The method of claim 28, wherein the step of configuring the second PE block with a predetermined number of PE modules comprises the steps of:
configuring the second PE block with a third module comprising the predetermined number of PEs that perform a multiplication and accumulation operation; and
configuring at least one fourth module comprising the predetermined number of PEs that perform an addition and logic calculation operation.

37. The method of claim 36, further comprising the step of configuring a local memory for storing data processed in the third and fourth modules.

38. The method of claim 36, wherein each of the modules comprises four PEs.
